(19) United States
(12) Patent Application Publication
(10) Pub. No.: US 2021/0086556 A1
(43) Pub. Date: Mar. 25, 2021

(54) WHEEL CASTER

(71) Applicant: Jeffrey James Sweeten, Port St. Lucie, FL (US)

(72) Inventor: Jeffrey James Sweeten, Port St. Lucie, FL (US)

(21) Appl. No.: 16/948,561

(22) Filed: Sep. 23, 2020

Related U.S. Application Data
(60) Provisional application No. 62/905,643, filed on Sep. 25, 2019.

(51) Int. Cl. B60B 33/08; B60B 33/00

(52) U.S. Cl. CPC B60B 33/08; B60B 2200/00; B60B 2360/102; B60B 2360/32; B60B 2360/70; B60B 2320/10; B60B 33/0005; B60B 2360/36; B60B 2900/115; B60B 2900/531; B60B 2900/721; B60B 2900/121; B60B 2900/541; B60B 2900/212; B60B 2900/1212; B60B 33/0028

(57) ABSTRACT

A wheel caster comprising a roller, and a two piece socket, wherein the two piece socket comprises a top housing, having a concave cavity to accept the roller in a freely rotatable configuration, a stem, to be inserted inside a leg of an object, and a bottom housing comprising an opening to allow a portion of the roller to extend below the bottom housing allowing the roller to contact a surface.

### CROSS-REFERENCE TO RELATED APPLICATIONS

This application claims the benefit of U.S. Provisional Application Ser. No. 62/905,643 filed Sep. 25, 2019, entitled “Wheel Caster”, which is incorporated herein by reference in its entirety.

### FIELD OF INVENTION

Embodiments disclosed herein relate, in general, to a wheel caster and, more particularly, to a center mounted spherical wheel caster for various applications such as, but not limited to, a marine dock/boarding stairs.

### BACKGROUND

Numerous wheel casters are adapted to use a wheel rotably mounted within a housing which is attached under an object to make it easier to move. Currently, 360 degree rotating offset wheels are used on all known wheeled systems. However, such wheels often include a swivel mechanism subject to multiple points of failure, including, but not limited to, a failure associated with an excess swivel offset, and kingbolt/rivet failures. These wheels are often heavier in weight and can apply a large amount of stress to a surface on which they are being moved.

Moreover, the small diameters of the conventional wheels makes negotiating even small obstacles difficult. However, increasing a diameter of the wheels creates a destabilizing effect by raising the center of mass of a load carried by the wheels. In some conventional wheel casters, movement is also restricted in some directions, which can further cause trouble while navigating a load from one place to another.

Thus, there is a need for a simpler and easy to operate wheel caster that can be used to easily navigate an object in any direction.

### SUMMARY

Embodiments in accordance with the present invention provide a wheel caster comprising a roller within a socket. In some embodiments of the present invention, the roller comprises a solid sphere. The roller may also comprise a plurality of semi-spherical balls connected to one another. Further, the wheel caster comprises a two piece socket, wherein the two piece socket comprises a top housing, having a concave cavity to accept the roller in a freely rotatable configuration. Further, the top housing comprises a stem, to be inserted inside a leg of an object, wherein an O-ring is wrapped along a circumference of the stem within a notch. Further, the top housing comprising a plurality of top connection sockets protruding horizontally outwards from a base of the top housing. The two piece socket further comprising a bottom housing, having a plurality of bottom connection sockets, to accept a plurality of fasteners to attach the bottom housing with the top housing when each of the bottom connection sockets are aligned with each of the top connection sockets.

Embodiments in accordance with the present invention provide a wheel caster comprising a roller, having a plurality of semi-spherical balls connected to one another. Further, the wheel caster comprises a two piece socket, wherein the two piece socket comprises a top housing having a concave cavity to accept the roller in a freely rotatable configuration. Further, the top housing comprises a stem to be inserted inside a leg of an object, wherein an O-ring is wrapped along a circumference of the stem within a notch having a height of 0.125 inch and a depth of 0.938 inch with respect to an outer surface of the stem. Further, the top housing comprises a plurality of top connection sockets protruding from a base of the top housing. The two piece socket further comprises a bottom housing, having a plurality of bottom connection sockets, to accept a plurality of fasteners to attach the bottom housing with the top housing when each of the bottom connection sockets are aligned with each of the top connection sockets.

Embodiments in accordance with the present invention provide a wheel caster comprising a roller within a socket. Further, the wheel caster comprises a two piece socket, wherein the two piece socket comprises a top housing attachably detached to a bottom housing forming a concave cavity to accept the roller in a freely rotatable configuration and a bottom housing. Further, the top housing comprises a stem, to be inserted inside a leg of an object, wherein an O-ring is wrapped along a circumference of the stem.

Embodiments in accordance with the present invention provide a wheel caster comprising a roller, having a plurality of semi-spherical balls connected to one another. Further, the wheel caster comprises a two piece socket comprising a top housing, having a concave cavity to accept the roller in a freely rotatable configuration. Further, the top housing comprises a stem, to be inserted inside a leg of an object, wherein an O-ring is wrapped along a circumference of the stem within a notch and a ring having a plurality of top connection sockets. Further, the two piece socket comprising a bottom housing, having a plurality of bottom connection sockets, to accept a plurality of fasteners to attach the bottom housing with the top housing when each of the bottom connection sockets are aligned with each of the top connection sockets.

Embodiments in accordance with the present invention may provide a number of advantages depending on its particular configuration. First, embodiments of the present invention provide a wheel caster having a spherical roller that allows a movement of the wheel caster in any direction and even on uneven surfaces. Next, embodiments of the present invention provide a wheel caster having an improved shear strength. Further, embodiments of the present invention provide a wheel caster having a lower number of components that can be easily cleaned and serviced.

Also, embodiments of the present invention provide a wheel caster designed specifically for a stress of weight of passengers ingress/egress on and off of a boat, as well as an ongoing rocking motion off a boat-dock combination due to different conditions, such as, but not limited to, wind, tides, etc. Further, the wheel caster of the present invention eliminates failures associated with an excess swivel offset and kingbolt/rivet failures. Embodiments of the present invention provide a bottom housing having a smooth inner surface similar to the inner surface of a top housing to reduce friction caused between the inner surface of the bottom housing and a freely rotatable roller.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a front view of a wheel caster, according to an embodiment of the present invention;

FIG. 1B illustrates a bottom perspective view of the wheel caster, according to an embodiment of the present invention;

FIG. 2A illustrates a front view of a wheel caster with a leg of an object, according to another embodiment of the present invention;

FIG. 2B illustrates a bottom view of the wheel caster, according to an embodiment of the present invention;

FIG. 2C illustrates a left side perspective view of the wheel caster, according to an embodiment of the present invention;

FIG. 2D illustrates another left side view of the wheel caster, according to an embodiment of the present invention;

FIG. 2E illustrates a bottom view of a top housing of the wheel caster, according to an embodiment of the present invention;

FIG. 2F illustrates a right side perspective view of the top housing of the wheel caster 200, according to an embodiment of the present invention;

FIG. 2G illustrates a bottom view of a bottom housing of the wheel caster, according to an embodiment of the present invention;

FIG. 2H illustrates dimensions of the wheel caster, according to an embodiment of the present invention;

FIG. 3A illustrates a front view of a wheel caster, according to another embodiment of the present invention;

FIG. 3B illustrates a top view of a top housing of the wheel caster, according to an embodiment of the present invention; and

FIG. 4 illustrates a flowchart of a method for installing the wheel caster in an object, according to an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

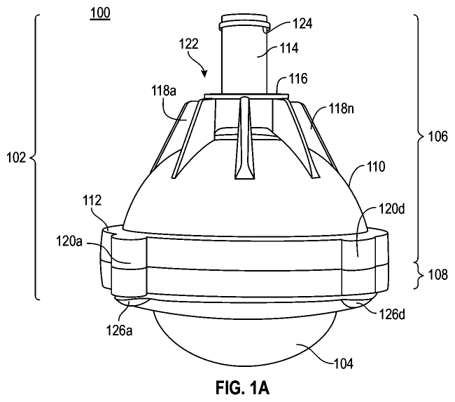

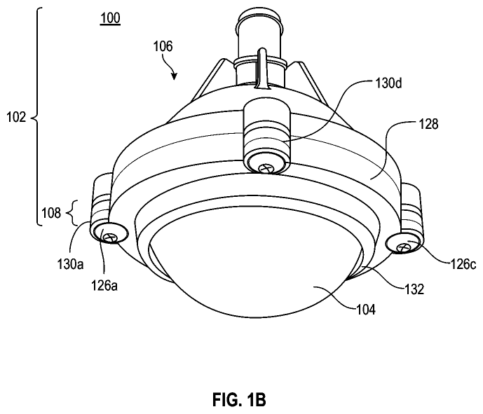

FIG. 1A illustrates a front view of a wheel caster 100, according to an embodiment of the present invention. The wheel caster 100 may be a wheel assembly that may allow a smooth movement of an object to which the wheel caster 100 is attached. According to embodiments of the present invention, the object may be, but not limited to, a chair, a ladder, a stool, a medical equipment, a cart, a marine stair, a wheeled vehicle, an unpowered vehicle, and so forth. Embodiments of the present invention are intended to include or otherwise cover any type of the object, including known, related art, and/or later developed technologies that may require to be moved from one place to another. Further, the surface may be, but not limited to, a flat surface, a smooth surface, an uneven surface, and so forth. Embodiments of the present invention are intended to include or otherwise cover any type of the surface, including known, related art, and/or later developed technologies.

According to an embodiment of the present invention, the wheel caster 100 may comprise a two piece socket 102 that may be capable of fixedly holding a freely rotatable roller 104 (hereinafter referred to as the roller 104) in an assembled configuration. Further, the two piece socket 102 may comprise a top housing 106, and a bottom housing 108 that may be connected to one another to form the assembled configuration of the two piece socket 102 for holding the roller 104. In an embodiment of the present invention, the top housing 106, and the bottom housing 108 in the assembled configuration of the two piece socket 102 may hold the roller 104 such that a portion of the roller 104 may extend below the bottom housing 108 allowing the roller 104 to contact the surface.

In an embodiment of the present invention, an inner surface of the top housing 106 may include at least a small center mount Teflon insert (not shown) at an underside of the top housing 106. The Teflon insert may engage with the roller 104 such that the Teflon insert reduces friction between the roller 104, and the inner surface of the top housing 106. Similarly, the bottom housing 108 may include a Teflon insert (not shown) at the inner surface of the bottom housing 108. The Teflon insert may engage with the roller 104 such that the Teflon insert reduces friction between the roller 104, and the inner surface of the bottom housing 108.

According to embodiments of the present invention, the roller 104 may be a spherical ball that may be capable of rotating freely within the two piece socket 102 when the top housing 106, and the bottom housing 108 are connected to one another to form the assembled configuration of the two piece socket 102. In an embodiment of the present invention, the roller 104 may be solid or formed by two hollow semi spherical balls that may be attachably detached to one another forming the roller 104. The roller 104 may be formed by a plurality of hollow semi spherical balls that may be attachably detached to one another forming the roller 104, in another embodiment of the present invention. In an embodiment of the present invention, the plurality of hollow semi spherical balls may be attached to one another using a fastener (not shown). The fastener may be, but not limited to, a screw, a drive screw, an eye bolt, a drywall crew, a decking screw, and so forth. Embodiments of the present invention are intended to include or otherwise cover any type of the fastener, including known, related art, and/or later developed technologies. In another embodiment of the present invention, the plurality of hollow semi spherical balls may be attached to one another using a snap fit mechanism (not shown). In yet another embodiment of the present invention, the plurality of hollow semi spherical balls may be capable of screwing together using a built in fastening mechanism (not shown). Further, the plurality of hollow semi spherical balls may be made up of a material such as, but not limited to, a Teflon, a ceramic, and so forth. In a preferred embodiment of the present invention, the plurality of hollow semi spherical balls may be made up of a stainless steel. Embodiments of the present invention are intended to include or otherwise cover any type of the material for making the hollow semi spherical balls, including known, related art, and/or later developed materials that may provide a durability to the roller 104.

According to an embodiment of the present invention, the top housing 106 of the two piece socket 102 may be a semi-spherical shaped rigid structure. The top housing 106 may comprise, but not limited to, a body 110, a base 112, a stem 114, a support 116, a plurality of support arms 118a-118n (hereinafter referred to as the support arms 118), and a plurality of top connection sockets 120a-120d (hereinafter referred to as the connection sockets 120). In an embodiment of the present invention, the top housing 106 may be fabricated through a molding process by using a material such as, but not limited to, a rubber, a natural plastic, a synthetic plastic, a metal, and so forth. Embodiments of the present invention are intended to include or otherwise cover type of the material for the molding of the top housing 106, including known, related art, and/or later developed materials. In an embodiment of the present invention, the base 112, the stem 114, the support 116, the support arms 118, and the top connection sockets 120 may be integrally molded with the body 110 as one single piece to form the top housing 106. In another embodiment of the present invention, the body 110, the base 112, the stem 114, the support 116, support arms 118, and the top connection sockets 120 may be molded as a plurality of separate pieces that may be assembled to form the top housing 106.

The body 110 of the top housing 106 may be a semi-spherical shaped structure having a concave cavity (not shown) that may be capable of accepting the roller 104 such that the roller 104 is freely rotatable within the concave cavity. According to embodiments of the present invention, the roller 104 may have a 360 degree angle of rotation with respect to the two piece socket 102 to allow the roller 104 to be moved in any direction and on any type of the surface. Further, the body 110 may support other components of the top housing 106, according to embodiments of the present invention. The base 112 of the top housing 106 may be a ring shaped structure that may have a diameter greater than the body 110. Further, the base 112 may extend horizontally outwards from the body 110 forming a ledge, according to an embodiment of the present invention. In an embodiment of the present invention, the stem 114 may be a connecting structure attached to a proximal end 122 of the body 110 for fixedly engaging the wheel caster 100 within an object such as, but not limited to, a leg of the object (not shown). A shape of the stem 114 may be, but not limited to, a cylinder, a square, a rectangle, and so forth. Embodiments of the present invention are intended to include or otherwise cover any shape of the stem 114, including known, related art, and/or later developed technologies. Further, the stem 114 may comprise a notched aluminum pin (not shown) that may be embedded within the stem 114 during the molding process, which may be capable of providing an improved shear strength to the stem 114, in an embodiment of the present invention. Furthermore, the stem 114 may comprise an O-ring 124 wrapped along a circumference of the stem 114 onto a notch (not shown) that may enable a secure fit of the wheel caster 100 within the leg of the object to which the wheel caster 100 is attached. According to embodiments of the present invention, the O-ring 124 may be made up of a material such as, but not limited to, a natural rubber, a synthetic rubber, a plastic, and so forth. Embodiments of the present invention are intended to include or otherwise cover any type of the material for the O-ring 124, including known, related art, and/or later developed materials.

Further, the proximal end 122 of the body 110 may comprise the support 116 that may be provided to act as a stopper for the leg of the object attached to the wheel caster 100, in an embodiment of the present invention. The support 116 that may also be attached to a distal end of the stem 114, which restricts a movement of the leg of the object. The support 116 may be a washer, in an embodiment of the present invention. The support 116 may be made up of a material such as, but not limited to, a stainless steel, a copper, an iron, an aluminum, and so forth. Embodiments of the present invention are intended to include or otherwise cover any type of the material for the support 116, including known, related art, and/or later developed materials. According to an embodiment of the present invention, the support 116 may be further attached to the support arms 118. Each of the support arms 118 may be a v-shaped arm having a bottom edge and a vertical side edge. Further, the bottom edge of each of the support arms 118 may be attached to a top surface of the body 110, and the vertical side edge of each of the support arms 118 may be attached to the stem 114 forming a webbing around the stem 114, in an embodiment of the present invention.

According to embodiments of the present invention, the top connection sockets 120 may be a semi cylindrical socket that may be protruded horizontally outwards from the ledge of the base 112. Further, the top connection sockets 120 may have a threaded cavity (not shown) pointing in a downward direction that may be capable of accepting a plurality of fasteners 126a-126d (hereinafter referred to as the fasteners 126). According to embodiments of the present invention, the fasteners 126 may be, but not limited to, a screw, a drive screw, an eye bolt, a drywall crew, a decking screw, and so forth. Embodiments of the present invention are intended to include or otherwise cover any type of the fasteners 126, including known, related art, and/or later developed technologies.

FIG. 1B illustrates a bottom perspective view of the wheel caster 100, according to an embodiment of the present invention. The wheel caster 100 may comprise the two piece socket 102 that may be capable of fixedly holding the roller 104 in the assembled configuration. Further, the two piece socket 102 may comprise the top housing 106, as explained above in conjunction with the FIG. 1A. Furthermore, the two piece socket 102 may comprise the bottom housing 108 that may be connected to the top housing 106 to form the assembled configuration of the two piece socket 102 for holding the roller 104 within the concave cavity. According to an embodiment of the present invention, the bottom housing 108 may be a circular shaped rigid structure. The structure of the bottom housing 108 may be fabricated through the molding process by using a material such as, but not limited to, a natural plastic, a synthetic plastic, a metal, and so forth. Embodiments of the present invention are intended to include or otherwise cover any type of the material for the molding of the bottom housing 108, including known, related art, and/or a later developed materials. Further, the bottom housing 108 may comprise a ring 128, a plurality of bottom connection sockets 130a-130d (hereinafter referred to as the bottom connection sockets 130), and a support lip 132, according to an embodiment of the present invention.

The ring 128 may be a circular shaped structure that may be provided to support the bottom connection sockets 130, and the support lip 132, in an embodiment of the present invention. The bottom connection sockets 130 may be a semi cylindrical socket that may be protruded horizontally outwards from an outer surface of the ring 128. Further, the bottom connection sockets 130 may comprise a hole (not shown) that may be capable of accepting the fasteners 126 for attaching the bottom housing 108 with the top housing 106, according to an embodiment of the present invention. Each of the bottom connection sockets 130 may be first aligned with the top connection sockets 120 and then accepts the fasteners 126 to assemble the two piece socket 102.

The support lip 132 may be an L-shaped lip that may be extending vertically downwards from the ring 128 forming a horizontal ledge with the ring 128, in an embodiment of the present invention. Further, the support lip 132 may have a diameter that may be smaller than a diameter of the ring 128 such that the support lip 132 encloses the roller 104 within the two piece socket 102 when the top housing 106 and the bottom housing 108 are attached to one another, according to an embodiment of the present invention.

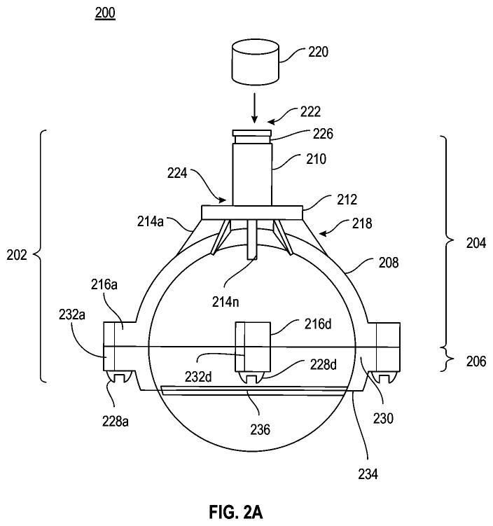

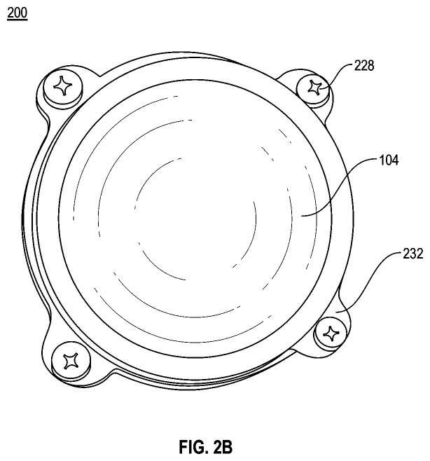

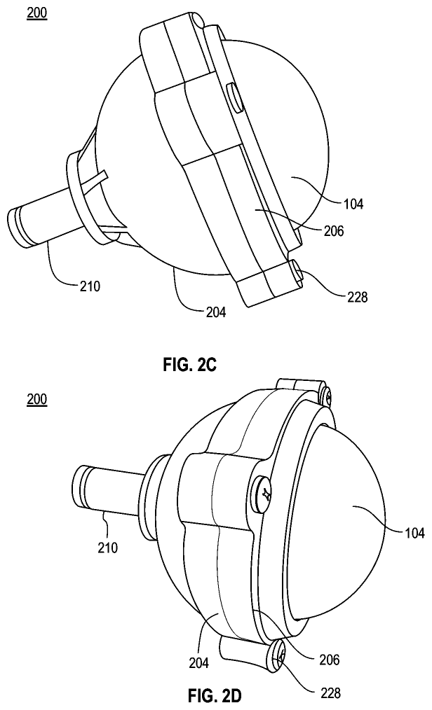

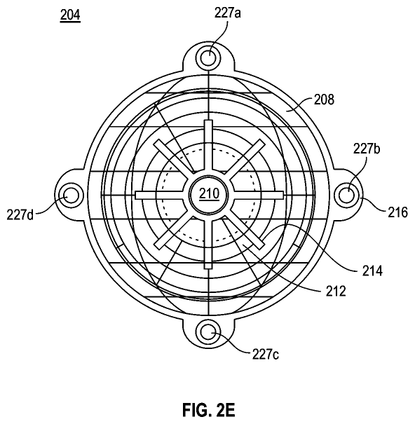

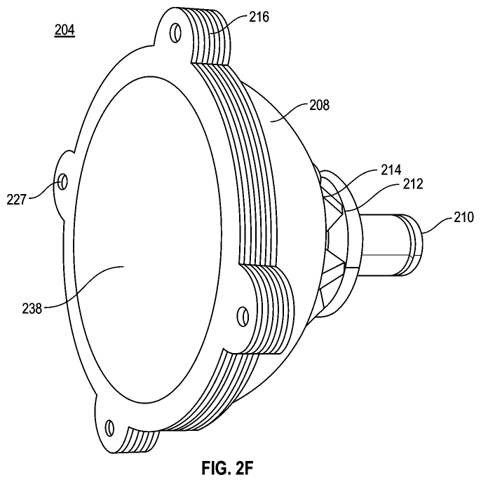

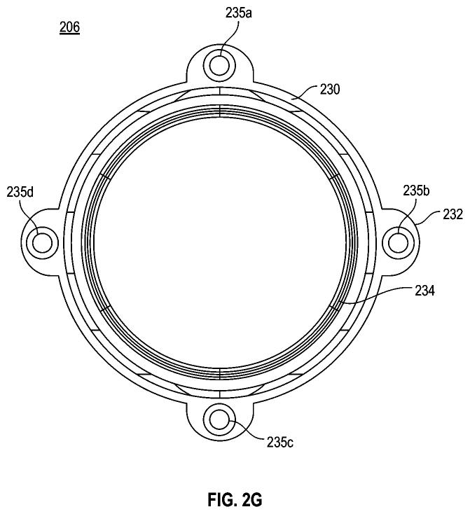

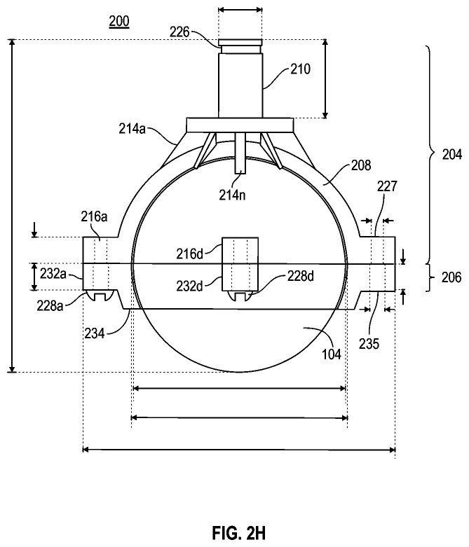

FIG. 2A illustrates a front view of a wheel caster 200 with a leg of an object, according to another embodiment of the present invention. The wheel caster 200 may comprise a two piece socket 202, and the roller 104. According to an embodiment of the present invention, the two piece socket 202 may comprise a top housing 204, and a bottom housing 206 that may be connected to one another to form an assembled configuration of the two piece socket 202 for holding the roller 104. Further, the top housing 204 and the bottom housing 206 in the assembled configuration of the two piece socket 202 may hold the roller 104 such that a portion of the roller 104 may extend below the bottom housing 206 allowing the roller 104 to contact a surface. In other embodiments of the present invention, the assembled configuration of the two piece socket 202 may hold the roller 104 allowing a ¼^{th} portion of the roller 104 to contact a surface. According to embodiments of the present invention, the roller 104 may be a spherical ball, as explained above in conjunction with the FIG. 1A.

According to an embodiment of the present invention, the top housing 204 of the two piece socket 202 may be a semi-spherical shaped rigid structure that may comprise a body 208, a stem 210, a support 212, a plurality of support arms 214a-214n (hereinafter referred to as the support arms 214), and a plurality of top connection sockets 216a-216d (hereinafter referred to as the connection sockets 216). In an embodiment of the present invention, the top housing 204 may be fabricated through a molding process by using a material such as, but not limited to, a natural plastic, a synthetic plastic, a metal, and so forth. In a preferred embodiment of the present invention, the top housing 204 may be made up of recycled polyethylene plastic. Embodiments of the present invention are intended to include or otherwise cover any type of the material for the molding of the top housing 204, including known, related art, and/or later developed materials. In an embodiment of the present invention, the stem 210, the support 212, the support arms 214, and the top connection sockets 216 may be integrally molded with the body 208 as one single piece to form the top housing 204. In another embodiment of the present invention, the body 208, the stem 210, the support 212, the support arms 214, and the top connection sockets 216 may be molded as a plurality of separate pieces assembled together to form the top housing 204.

The body 208 of the top housing 204 may be a semi-spherical shaped structure when combined with the bottom housing 206 may create a concave cavity 238 (as shown in FIG. 2F). The concave cavity 238 may be capable of accepting the roller 104 such that the roller 104 is freely rotatable within the concave cavity 238. Further, the roller 104 may have a 360 degree angle of rotation with respect to the two piece socket 202 to allow the roller 104 to be moved in any direction and on any type of the surface. The body 208 may be further capable of supporting other components of the top housing 204, according to embodiments of the present invention. In an embodiment of the present invention, the stem 210 may be a connecting structure that may be attached to a proximal end 218 of the body 208 for fixedly engaging the wheel caster 100 within a leg 220 of an object (not shown). Further, the stem 210 may be a centrally mounted structure having a shape such as, but not limited to, a cylinder, a square, a rectangle, and so forth. Embodiments of the present invention are intended to include or otherwise cover any type of the shape of the stem 210, including known, related art, and/or a later developed technologies. Further, the stem 210 may comprise a proximal end 222, and a distal end 224, in an embodiment of the present invention. Further, the proximal end 222 of the stem 210 may comprise a notch 226 that may be designed to fixedly couple the stem 210 within the leg 220 of the object when the wheel caster 200 is snapped and locked within the leg 220 by pushing the stem 210 of the wheel caster 200 into the leg 220, according to an embodiment of the present invention. Furthermore, the stem 210 may comprise an O-ring 124 (as shown in the FIG. 1A) wrapped along a circumference of the stem 210 within the notch 226 to enable a secure fit of the wheel caster 100 within the leg 220 of the object to which the wheel caster 100 is attached. In an embodiment of the present invention, the stem 210 may comprise a notched aluminum pin (not shown) that may be embedded within the stem 210 during the molding process, which may be capable of providing an improved shear strength to the stem 210.

Further, the distal end 224 of the stem 210 may be attached to the support 212 that may be provided to act as a stopper for the leg 220 of the object attached to the wheel caster 200, in an embodiment of the present invention. The support 212 may be a washer that may be made up of a material such as, but not limited to, a stainless steel, a copper, an iron, an aluminum, and so forth. Embodiments of the present invention are intended to include or otherwise cover type of the material for the support 212, including known, related art, and/or later developed materials. According to an embodiment of the present invention, the support 212 may be further attached to the support arms 214 such that each of the support arms 214 may be a v-shaped arm having a bottom edge and a vertical side edge. Further, the bottom edge of the support arms 214 may be attached to a top surface of the body 208 and the vertical side edge of the support arms 214 may be attached to the stem 210 forming a webbing around the stem 210 to impart strength to the wheel caster 200, according to an embodiment of the present invention.

According to embodiments of the present invention, the top connection sockets 216 may be a semi cylindrical socket that may be protruded horizontally outwards along a circumference of the body 208 near a bottom end. Further, the top connection sockets 216 may have a plurality of threaded cavity 227a-227d (hereinafter referred to as the threaded cavity 227), as shown in FIG. 2E, pointing in a downward direction, which may be capable of accepting a plurality of fasteners 228a-228d (hereinafter referred to as the fasteners 228) for connecting the top housing 204 with the bottom housing 206, in an embodiment of the present invention. According to embodiments of the present invention, the fasteners 228 may be, but not limited to, a screw, a drive screw, an eye bolt, a drywall crew, a decking screw, and so forth. Embodiments of the present invention are intended to include or otherwise cover any type of the fasteners 228, including known, related art, and/or later developed technologies. In another embodiment of the present invention, the top housing 204 and the bottom housing 206 may be attached with one another through a locking mechanism such as, but not limited to, a snap lock, a rivet, a twist lock, and so forth. Embodiments of the present invention are intended to include or otherwise cover any type of the locking mechanism, including known, related art, and/or later developed technologies.

According to an embodiment of the present invention, the bottom housing 206 of the two piece socket 202 may be a circular shaped rigid structure that may be fabricated through the molding process by using a material such as, but not limited to, a natural plastic, a synthetic plastic, a metal, and so forth. Embodiments of the present invention are intended to include or otherwise cover any type of the material for the molding of the bottom housing 206, including known, related art, and/or a later developed materials. Further, the bottom housing 206 may comprise a ring 230, a plurality of bottom connection sockets 232a-232d (hereinafter referred to as the bottom connection sockets 232), and a support lip 234, according to an embodiment of the present invention.

The ring 230 may be a circular shaped structure that may be provided to support the bottom connection sockets 232 and the support lip 234, in an embodiment of the present invention. The bottom connection sockets 232 may be a semi cylindrical socket that may be protruded horizontally outwards from an outer surface along a circumference of the ring 230. Further, the bottom connection sockets 232 may comprise a plurality of holes 235a-235d (hereinafter referred to as the hole 235), as shown in FIG. 2G, which may be capable of accepting the fasteners 228 for attaching the bottom housing 206 with the top housing 204, according to an embodiment of the present invention. The support lip 234 may be an L-shaped lip that may be extending vertically downwards from the ring 230 forming a horizontal ledge with the ring 230, in an embodiment of the present invention. Further, the support lip 234 may have a diameter that may be smaller than a diameter of the ring 230 such that the support lip 234 encloses the roller 104 within the two piece socket 202 when the top housing 204 and the bottom housing 206 are attached to one another, according to embodiments of the present invention.

According to an embodiment of the present invention, the bottom housing 206 may comprise a wiper 236. The wiper 236 may be made of a material such as, but not limited to, a polyethylene plastic, a synthetic material, a rubber, and so forth. Embodiments of the present invention are intended to include or otherwise cover any type of the material for the wiper 236, including known, related art, and/or a later developed materials. In an embodiment of the present invention, the wiper 236 may be removably attached to the bottom housing 206 to restrict debris and dust from entering the two piece socket 202. Further, the wiper 236 may be positioned along the circumference of the ring 230 of the bottom housing 206. The wiper 236 may further comprise a plurality of feathers (not shown) that may enable a cleaning of the roller 104 while the roller 104 rotates inside the two piece socket 202, according to embodiments of the present invention. Further, the feathers may extend vertically downwards from the wiper 236, in an embodiment of the present invention. In another embodiment of the present invention, an edge of the support lip 234 of the bottom housing 206 may create a wiping effect to prevent dirt, and dust from entering the wheel caster 200.

FIG. 2B illustrates a bottom view of the wheel caster 200, according to an embodiment of the present invention. The wheel caster 200 comprises the two piece socket 202 (as shown in the FIG. 2A), and the roller 104. According to an embodiment of the present invention, the two piece socket 202 may comprise the top housing 204 and the bottom housing 206 (as shown in the FIG. 2A) that may be connected to one another using the fasteners 228 for holding the roller 104. Further, the top housing 204 and the bottom housing 206 in the assembled configuration of the two piece socket 202 may hold the roller 104 such that a portion of the roller 104 may extend below the bottom housing 206 allowing the roller 104 to contact the surface. In another embodiment of the present invention the two piece socket 202 may hold the roller 104 such that a ¼^{th} portion of the roller 104 may extend below the bottom housing 206 allowing the roller 104 to contact the surface.

FIG. 2C illustrates a left side perspective view of the wheel caster 200, according to an embodiment of the present invention. The wheel caster 200 comprises the top housing 204 and the bottom housing 206 that may be connected to one another using the fasteners 228 for holding the roller 104. Further, the top housing 204 may comprise the stem 210 that may be provided to attach the wheel caster 200 to the leg 220 of the object, as discussed above in conjunction with the FIG. 2A, according to an embodiment of the present invention.

FIG. 2D illustrates another left side view of the wheel caster 200, according to an embodiment of the present invention. The wheel caster 200 may be assembled by attaching the top housing 204 and the bottom housing 206 together using the fasteners 228. Further, the assembled wheel caster 200 may hold the roller 104 such that a portion of the roller 104 may extend below the bottom housing 206 allowing the roller 104 to contact the surface. In another embodiment of the present invention the two piece socket 202 may hold the roller 104 such that a ¼^{th} portion of the roller 104 may extend below the bottom housing 206 allowing the roller 104 to contact the surface. Furthermore, the stem 210 may be provided to attach the wheel caster 200 to the leg 220 (as shown in the FIG. 2A) of the object by inserting the stem 210 into the leg 220 of the object, according to an embodiment of the present invention.

FIG. 2E illustrates a bottom view of the top housing 204 of the wheel caster 200, according to an embodiment of the present invention. The top housing 204 may comprise the body 208, the stem 210, the support 212, the support arms 214, and the top connection sockets 216. The body 208 of the top housing 204 may be capable of accepting the roller 104 such that the roller 104 is freely rotatable within the concave cavity 238 (as shown in the FIG. 2F). In an embodiment of the present invention, the stem 210 may be attached to the body 208 for fixedly engaging the wheel caster 200 within the leg 220 (as shown in the FIG. 2A) of the object. Further, the stem 210 may be attached to the support 212 that may be provided to act as the stopper for the leg 220 of the object attached to the wheel caster 200, in an embodiment of the present invention. According to an embodiment of the present invention, the support 212 may be further attached to the support arms 214 that may be molded such that the support arms 214 extend into the concave cavity 238. The support arms 214 may be further capable of providing a separation between the roller 104 and an inner surface of the body 208 when the roller 104 is held within the concave cavity 238 of the top housing 204, according to an embodiment of the present invention. According to embodiments of the present invention, the top connection sockets 216 may be provided to attach the top housing 204, with the bottom housing 206 using the fasteners 228 (as shown in the FIG. 2A). Further, the top connection sockets 216 may have the threaded cavity 227 pointing in the downward direction that may be capable of accepting the fasteners 228, in an embodiment of the present invention.

FIG. 2F illustrates a right side perspective view of the top housing 204 of the wheel caster 200, according to an embodiment of the present invention. The top housing 204 may comprise the body 208, the stem 210, the support 212, the support arms 214, and the top connection sockets 216, as discussed above in conjunction with the FIG. 2A. Further, the top connection sockets 216 may have the threaded cavity 227 pointing in the downward direction that may be capable of accepting the fasteners 228, in an embodiment of the present invention. Furthermore, the body 208 of the top housing 204 may comprise the concave cavity 238 that may be capable of accepting the roller 104 such that the roller 104 is freely rotatable within the top housing 204, according to embodiments of the present invention.

FIG. 2G illustrates a bottom view of the bottom housing 206 of the wheel caster 200, according to an embodiment of the present invention. The bottom housing 206 may comprise the ring 230, the bottom connection sockets 232, and the support lip 234, as discussed above in conjunction with the FIG. 2A. Further, the bottom connection sockets 232 may comprise the hole 235 that may be capable of accepting the fasteners 228 (as shown in the FIG. 2A) for attaching the bottom housing 206 with the top housing 204, according to an embodiment of the present invention.

FIG. 2H illustrates dimensions of the wheel caster 200, according to an embodiment of the present invention. A height of the wheel caster 200 may be 6.30 inches and a width of the wheel caster 200 may be 5.88 inches, according to an embodiment of the present invention. Further, the top housing 204 may have an internal diameter of 4.10 inches. The top housing 204 may further comprise the stem 210 having a height of 1.5 inches, and a width of 0.87 inches. The stem 210 may further comprise the notch 226 having a height of 0.125 inch. Further, the notch 226 may have a depth of 0.938 inch with respect to an outer surface of the stem 210, according to an embodiment of the present invention. According to embodiments of the present invention, the roller 104 may have a diameter of 4.00 inches. Further, the top connection sockets 216 and the bottom connection sockets 232 may have a height of 0.5 inches. Further, the top connection sockets 216 may comprise the threaded cavity 227 having a diameter of 0.22 inch, in an embodiment of the present invention. The bottom connection sockets 232 may comprise the hole 235 having a diameter of 0.27 inch, in an embodiment of the present invention. A height of the support lip 234 of the bottom housing 206 may be 0.85 inch, according to an embodiment of the present invention.

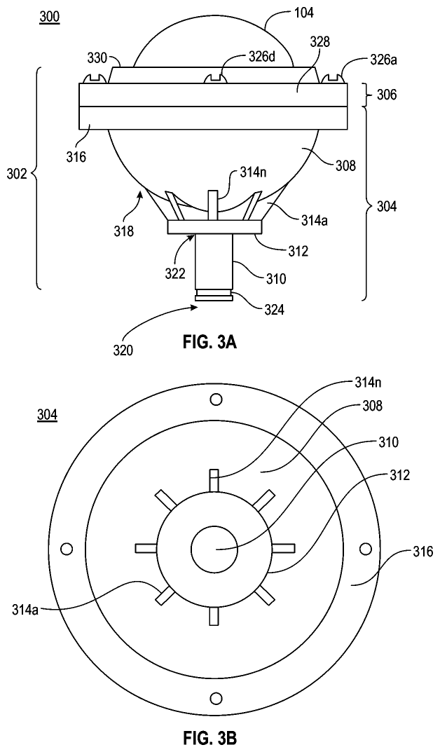

FIG. 3A illustrates a front view of a wheel caster 300, according to another embodiment of the present invention. The wheel caster 300 may comprises a two piece socket 302 and the roller 104. According to an embodiment of the present invention, the two piece socket 302 may comprise a top housing 304 and a bottom housing 306 that may be connected to one another to form an assembled configuration of the two piece socket 302 for holding the roller 104. Further, the top housing 304 and the bottom housing 306 in the assembled configuration of the two piece socket 302 may hold the roller 104 such that a ¼^{th} portion of the roller 104 may extend below the bottom housing 306 allowing the roller 104 to contact a surface. According to embodiments of the present invention, the roller 104 may be a spherical ball as explained above in conjunction with the FIG. 1A.

According to an embodiment of the present invention, the top housing 304 of the two piece socket 302 may be a semi-spherical shaped rigid structure that may comprise a body 308, a stem 310, a support 312, a plurality of support arms 314a-314n (hereinafter referred to as the support arms 314), and a base 316. In an embodiment of the present invention, the top housing 304 may be fabricated through a molding process by using a material such as, but not limited to, a natural plastic, a synthetic plastic, a metal, and so forth. Embodiments of the present invention are intended to include or otherwise cover any type of the material for the molding of the top housing 304, including known, related art, and/or later developed materials. In an embodiment of the present invention, the stem 310, the support 312, the support arms 314, and the base 316 may be integrally molded with the body 308 as one single piece to form the top housing 304. In another embodiment of the present invention, the body 308, the stem 310, the support 312, the support arms 314, and the base 316 may be molded as a plurality of separate pieces that may be assembled to form the top housing 304.

The body 308 of the top housing 304 may be a semi-spherical shaped structure having a concave cavity (not shown) that may be capable of accepting the roller 104 such that the roller 104 is freely rotatable within the concave cavity. The roller 104 may have a 360 degree angle of rotation with respect to the two piece socket 302 to allow the roller 104 to be moved in any direction and on any of the surface. The body 308 may be further capable of supporting other components of the top housing 304, according to embodiments of the present invention. In an embodiment of the present invention, the stem 310 may be a rigid connecting structure that may be attached to a proximal end 318 of the body 308 for fixedly engaging the wheel caster 300 within the leg 220 (as shown in the FIG. 2A) of the object (not shown). Further, the stem 310 may be a centrally mounted structure having a shape such as, but not limited to, a cylinder, a square, a rectangle, and so forth. Embodiments of the present invention are intended to include or otherwise cover type of the shape of the stem 310, including known, related art, and/or a later developed technologies. Further, the stem 310 may comprise a proximal end 320 and a distal end 322, in an embodiment of the present invention. The proximal end 320 of the stem 310 may comprise a notch 324 that may be designed to fixedly couple the wheel caster 300 with the leg 220 of the object when the wheel caster 300 is snapped and locked within the leg 220 by pushing the stem 310 into leg 220, according to an embodiment of the present invention. Further, the stem 310 may comprise an O-ring 124 (as shown in the FIG. 1A) wrapped along a circumference of the stem 310 within the notch 324 to enable a secure fit of the wheel caster 300 within the leg of the object to which the wheel caster 300 is attached. In an embodiment of the present invention, the stem 310 may comprise a notched aluminum pin (not shown) that may be embedded within the stem 310 during the molding process that may be capable of providing an improved shear strength to the stem 310.

Further, the distal end 322 of the stem 310 may be attached to the support 312 that may be provided to act as a stopper for the leg 220 of the object (not shown) attached to the wheel caster 300 such that the support 312 restricts a further movement of the leg 220 in a downward direction, in an embodiment of the present invention. The support 312 may be a washer that may be made up of a material such as, but not limited to, a stainless steel, a copper, an iron, an aluminum, and so forth. Embodiments of the present invention are intended to include or otherwise cover any type of the material for the support 312, including known, related art, and/or later developed materials. According to an embodiment of the present invention, the support 312 may be further attached to the support arms 314 such that each of the support arms 314 may be a v-shaped arm having a bottom edge and a vertical side edge. Further, the bottom edge of the support arms 314 may be attached to a top surface of the body 308 and the vertical side edge of the support arms 314 may be attached to the stem 310 forming a webbing around the stem 310 to impart strength to the wheel caster 300, according to an embodiment of the present invention.

According to embodiments of the present invention, the base 316 may be an L-shaped ledge protruding horizontally outwards from the body 308 along a circumference of the top housing 304. Further, the base 316 may comprise a plurality of top connection sockets (not shown) that may have a threaded cavity (not shown) pointing in a downward direction that may be capable of accepting a plurality of fasteners 326a-326d (hereinafter referred to as the fasteners 326) for connecting the top housing 304 with the bottom housing 306, in an embodiment of the present invention. According to embodiments of the present invention, the fasteners 326 may be, but not limited to, a screw, a drive screw, an eye bolt, a drywall crew, a decking screw, and so forth. Embodiments of the present invention are intended to include or otherwise cover any type of the fasteners 326, including known, related art, and/or later developed technologies. In another embodiment of the present invention, the top housing 304 and the bottom housing 306 may be attached with one another through a locking mechanism such as, but not limited to, a snap lock, a rivet, a twist lock, and so forth. Embodiments of the present invention are intended to include or otherwise cover any type of the locking mechanism, including known, related art, and/or later developed technologies.

According to an embodiment of the present invention, the bottom housing 306 of the two piece socket 302 may be a circular shaped rigid structure that may be fabricated through the molding process by using a material such as, but not limited to, a natural plastic, a synthetic plastic, a metal, and so forth. Embodiments of the present invention are intended to include or otherwise cover type of the material for the molding of the bottom housing 306, including known, related art, and/or a later developed materials. Further, the bottom housing 306 may comprise a ring 328, and a support lip 330, according to an embodiment of the present invention. The ring 328 may be a circular shaped structure that may comprise a plurality of bottom connection sockets (not shown) and the support lip 330, in an embodiment of the present invention. The bottom connection sockets may be a semi cylindrical socket that may be provided along a circumference of the ring 328. Further, the bottom connection sockets may comprise a hole (not shown) that may be capable of accepting the fasteners 326 for attaching the bottom housing 306 with the top housing 304, according to an embodiment of the present invention. The support lip 330 may be an L-shaped lip that may be extending vertically downwards from the ring 328 forming a horizontal ledge with the ring 328, in an embodiment of the present invention. Further, the support lip 330 may have a diameter that may be smaller than a diameter of the ring 328 such that the support lip 330 encloses the roller 104 within the two piece socket 302 when the top housing 304 and the bottom housing 306 are attached to one another, according to embodiments of the present invention. In an embodiment of the present invention, an edge of the support lip 330 of the bottom housing 306 may create a wiping effect to prevent dirt, and dust from entering the wheel caster 300.

FIG. 3B illustrates a top view of the top housing 304 of the wheel caster 300, according to an embodiment of the present invention. The top housing 304 may comprise the body 308, the stem 310, the support 312, the support arms 314, and the base 316 as discussed above in conjunction with the FIG. 3A.

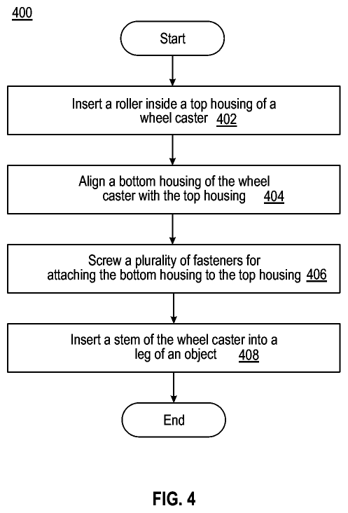

FIG. 4 illustrates a flowchart of a method 400 for installing the wheel caster 200 in an object, according to an embodiment of the present invention.

At step 402, a user may insert the roller 104 inside the concave cavity 238 of the top housing 204 of the wheel caster 200.

Further, at step 404, the user may align the bottom housing 206 with the top housing 204 such that the bottom connection sockets 232 and the top connection sockets 216 aligns with one another.

At step 406, the user may insert the fasteners 228 into the bottom connection sockets 232 to screw the fasteners 228 for attaching the bottom housing 206 with the top housing 204.

At step 408, the user may insert the stem 210 of the wheel caster 200 inside the leg 220 of the object to fixedly attach the wheel caster 200 with the object.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure.

The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the disclosure to the precise form disclosed.

Modifications and variations are possible in light of the above teachings or may be acquired from practice of the disclosure. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

What is claimed is:

1. A wheel caster comprising:
a roller; and
a socket comprising:
a top housing, having a concave cavity to accept the roller in a freely rotatable configuration, the top housing further comprising a stem to be attached to a leg of an object; and
a bottom housing detachably attached to the top housing to secure the roller, the bottom housing further comprising an opening to allow a portion of the roller to extend through and below the bottom housing allowing the roller to contact a surface.

2. The wheel caster of claim 1, wherein the top housing further comprises a plurality of top connection sockets protruding horizontally outwards from a base of the top housing.

3. The wheel caster of claim 1, wherein the bottom housing further comprises a plurality of bottom connection sockets, to accept a plurality of fasteners to attach the bottom housing with the top housing.

4. The wheel caster of claim 1, wherein the stem further comprises a notch to accept an O-ring around the circumference of the stem to secure the wheel caster to an object.

5. The wheel caster of claim 1, wherein the roller is made up of a material selected from a group comprising one of, a stainless steel, a Teflon, a ceramic, or a combination thereof.

6. The wheel caster of claim 1, wherein the roller comprises a plurality of semi-spherical balls connected to one another.

7. The wheel caster of claim 1, wherein the top housing further comprises a support attached to a distal end of the stem to restrict movement of the leg of the object.

8. The wheel caster of claim 1, wherein the bottom housing further comprises a ring and a support lip such that a diameter of the support lip is smaller than a diameter of the ring.

9. The wheel caster of claim 1, wherein the top housing further comprises plurality of support arms.

10. The wheel caster of claim 1, wherein the top housing further comprises a Teflon insert to reduce friction between the roller and the top housing.

11. A wheel caster comprising:
a roller, having a plurality of semi-spherical balls connected to one another; and
a two piece socket comprising:
a top housing, having a concave cavity to accept the roller in a freely rotatable configuration, wherein the top housing comprises:
a stem, to be inserted inside a leg of an object;
an O-ring wrapped around a circumference of the stem; and
a plurality of top connection sockets protruding horizontally outwards from a base of the top housing; and
a bottom housing, having a plurality of bottom connection sockets, to accept a plurality of fasteners to attach the bottom housing with the top housing when each of the bottom connection sockets are aligned with each of the top connection sockets.

12. The wheel caster of claim 11, wherein the top housing further comprises a support attached to a distal end of the stem to restrict a movement of the leg of the object.

13. The wheel caster of claim 11, wherein the top housing further comprises a plurality of support arms.

14. The wheel caster of claim 11, wherein the bottom housing further comprises a ring and a support lip such that a diameter of the support lip is smaller than a diameter of the ring.

15. The wheel caster of claim 11, wherein the top housing further comprises a Teflon insert to reduce friction between the roller and the top housing.

16. The wheel caster of claim 11, wherein the bottom housing further comprises a wiper detachably attached along a circumference of the bottom housing.

17. A wheel caster comprising:
a roller;
a top housing, having a concave cavity to accept the roller in a freely rotatable configuration, the top housing further comprising a stem having a plurality of support arms, an O-ring wrapped around a circumference of the stem and a plurality of top connection sockets; and
a bottom housing, having an opening to allow a portion of the roller to extend through and below the bottom housing to allow the roller to contact a surface, and a plurality of bottom connection sockets, to accept a plurality of fasteners to attach the bottom housing with the top housing when each of the bottom connection sockets are aligned with each of the top connection sockets.

18. The wheel caster of claim 17, wherein the top housing further comprises a Teflon insert to reduce friction between the roller and the top housing.

19. The wheel caster of claim 17, wherein the top housing further comprises a support attached to a distal end of the stem to restrict a movement of the leg of the object.

20. The wheel caster of claim 19, wherein the support is attached to the plurality of support arms.
